(19) United States
(12) Patent Application Publication
(10) Pub. No.: US 2011/0197123 A1
(43) Pub. Date: Aug. 11, 2011

(54) System and Method for Linking Images Between Websites to Provide High-Resolution Images From Low-Resolution Websites

(76) Inventors: Holden Caine, Boulder, CO (US); Seymen Ertas, Rochester, NY (US)

(21) Appl. No.: 12/703,414

(22) Filed: Feb. 10, 2010

(51) Int. Cl. G06F 17/00; G09G 5/00

(52) U.S. Cl. 715/234; 345/619

(57) ABSTRACT

A system and method that combines features of existing websites to link images between websites to create products with high-resolution images from sites that support only low-resolution data is provided. Even further, a system and method are provided for an integrated account management, image storage and product ordering means to upload images to multiple sites at once.

### FIELD OF THE INVENTION

The present invention is directed to a system and methodology that leverage features of existing websites to link images between websites to thereby avail products with high-resolution images from sites that support only low-resolution data. The present invention provides a system and method for an integrated account management, shared memory store, means to upload images to multiple distinct websites at once, and image management across multiple websites.

### BACKGROUND OF THE INVENTION

The ability and the need to distinguish and expand products and service offerings continue to be the driving force of today's economy. Solutions to provide enhanced services and improved user experiences continue to drive major enhancements and innovations to technological products. Intrinsic to this environment is how to better utilize existing mediums or products and leverage technologies or other services to facilitate such solutions. With the widespread use of the Internet, various online communities have developed. However, most of these communities have been developed as islands of features, each catering to particular niche products or services for their subscriber base. In other words, there are extremely few if any “bridges” between communities that enable subscribers to benefit from a “cross-pollination” or sharing of features available from each of the multiple distinct sites. For example, a typical social networking site such as facebook.com is geared toward soft display and therefore does not have a need for, or the ability to store image data at high resolutions to produce standard print products, such as 4×6 prints, at a quality level that consumers have become accustomed to receiving. The subscribers to facebook.com generally upload lots of images that they want to share with other subscribers, specifically those subscribers or users that are designated as friends.

These digital images may originate from a high-resolution source, such as a digital camera, scanner or other digital image storage device. If a friend or the originating subscriber wants a quality print of any of the online images from the social network site, there is currently no easy way to do so for the reasons stated earlier. As such, the original source images would have to be located, printed and then mailed or electronically transferred by the originating subscriber to the friend. Alternatively, the originating subscriber could locate the original source image and upload it to a photo service provider site that is designed for high-resolution image storage and printing, such as Flickr.com. Additionally, distribution facilities which may be native to such a site, like a fulfillment center, can be employed to provide high quality prints that could be shipped to the friend or picked up at a locally convenient location. These requirements to obtain a print are inconvenient, time consuming, tedious and not advantageous for either the originating subscriber or the friend.

Accordingly, there is a need for an efficient, seamless, user friendly and robust technique to provide the features or benefits of one website community to other website communities. More specifically, there is a need to enable access to high-resolution images and the offerings of a photo service processor to subscribers of a social network environment that only support low-resolution images. There is also a need for an efficient means by which friends can access, or subscribers can provide access, to the high-resolution versions of their images without a duplication of the uploading effort or the need to mail prints. What is also needed is system and method that enables additional products and applications from one website to be offered to existing subscribers of other websites. Even further means for combining the offerings of dissimilar web communities would be advantageous. There is a further need to provide program interfaces to enable and streamline such collaboration among existing websites.

The aspects of the present invention addresses these needs as well as other needs.

### SUMMARY OF THE INVENTION

The present invention is directed to a system and methodology that integrates image related features of a social network community with those of a photography community to provide high-resolution images to the social network subscribers. It is one aspect of the present invention to provide a method for storing and retrieving digital images while leveraging existing websites and their subscriber population. The method may comprise: a) receiving from a digital image to be uniquely identified and stored to a first system that supports low-resolution images; b) connecting to a second system that supports high-resolution image storage and processing; c) transferring a low-resolution format of the digital image to the first system and a high-resolution format of the digital image to the second system, the low-resolution image having a first a unique identifier and the high-resolution image having a second unique identifier; d) storing relatedly, the first and second unique identifiers to thereby link the low-resolution image to the high-resolution image whereby the high-resolution image may be obtained and provided to a user having access only to the first system when a copy or print of the digital image is requested.

It is a further aspect of the present invention to provide an application program interface (API), for use by third parties. The API may be used in conjunction with existing, distinct websites for the purpose of providing simultaneous storage of both a low and high-resolution format of digital images to separate sites. In other words, one format is stored to a first site and the other format is stored to a second site. It is an even further aspect of the present invention to provide a linking of the low and high-resolution format images across the multiple websites to thereby allow access to either format from either website.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawings, wherein:

FIG. 1 generally illustrates a networking environment in which the present invention may be implemented;

FIG. 2 is an illustration of component applications and a process for implementing the present invention;

FIG. 3 is a flow chart illustrating the steps of a method of providing image uploading according to an embodiment of the present invention;

FIG. 4 is flow chart illustrating the steps of a method for acquiring previously stored images according to an embodiment of the present invention; and

FIG. 5 is a block diagram generally illustrating a computing environment in which the invention may be implemented.

### DETAILED DESCRIPTION OF THE INVENTION

Generally, the tools and methods described herein for creating and implementing a linking of images across websites for the purpose of providing high-resolution images from sites that only support low-resolution images, may be implemented in hardware, software or a combination thereof.

This document is organized as follows: in the first section, an overview of the implementation is provided and described along with an exemplary network environment; in the next section, the operation of exemplary component applications for the implementation of the invention is discussed; following this, specific exemplary steps for the uploading of images and exemplary steps for the retrieval of images are described, including certain operational features of the present invention. Finally, an exemplary computer environment for the implementation of the invention is described.

### Overview of Implementation

The present invention is applicable to integrate features of a social network community with those of a photography community to provide high-resolution images from the low-resolution images that are available in the social network community. According to the present invention, a subscriber to the social network community that only supports low-resolution images, seeking to upload digital images to their individual profile will upload a low-resolution format of the image to the social network community. Transparent to the subscriber and simultaneous with low-resolution format upload, a high-resolution format will be uploaded to a photo service provider site. A link is established between both formats and both storage locations. Consequently, when that subscriber, other subscribers, or other duly authorized Internet user seeks to retrieve a copy of the image from the social network, the more detailed and better quality high-resolution format is transparently substituted and provided to the image requester.

The present invention introduces a number of concepts and a unique paradigm for the handling and processing of images. Certain key terms need to be addressed and understood in order to appreciate the invention. The present invention is described with reference to equipment, roles and processes that relate to images and more specifically, the application of images in an environment other than photography. However, as would be appreciated by one skilled in the art, the invention may be applicable to other processes and implementations, the references and discussion provided herein are strictly for illustrative purposes and are not intended to limit the scope of the invention.

A social network center as used herein refers to a social networking website where users (subscribers) can add friends, send messages, and update their personal profiles to notify friends about themselves. Users can also join networks organized by city, workplace, school, region and other similar groupings. The center also includes applications, where users can upload albums and photos.

A photo service provider can be defined as an entity or website that interacts directly or indirectly with customers to take photographic orders, digitize images, provide image storage, provide network access to digital images, etc., and process images as prints or compilations onto other mediums for customers.

A fulfillment center provides the end product and distribution (i.e., photo prints, compact disc (CD) of images, etc.) to the customer by direct shipment to the customer, by shipment to a store location, or other means.

A subscriber/content provider is a member of the social network, and originates content including digital images or other such expressions. The subscriber dictates the content to be uploaded and may provide permission to friends or the public to access the content.

An end user is the originator of requests for copies of one or more images or content. Using a web browser, the end user initiates a request for a copy, which could be a print, digital copy or other format. An end user includes the subscriber or any other user that has been granted access to the subscriber's content.

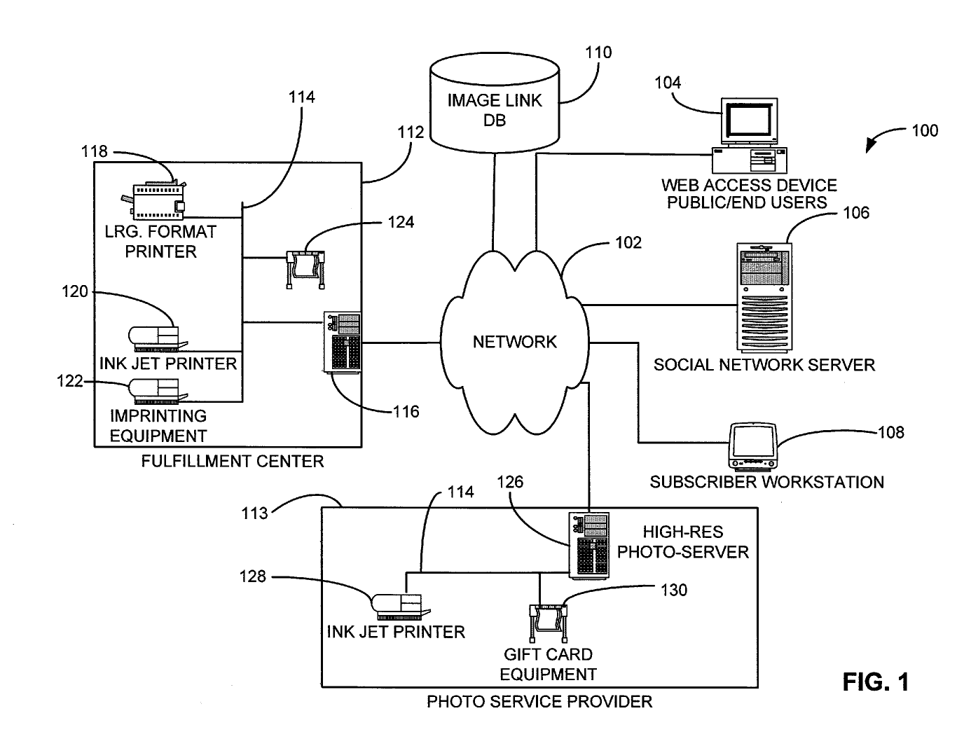

Having described some base concepts of the invention, aspects of the invention will now be described with reference to the drawing figures. An exemplary network environment in which the present invention could be implemented is shown in FIG. 1 and designated as reference numeral 100.

The environment 100 may include a network 102, such as a Local Area Network (LAN), Wide Area Network (WAN), the Internet, a wireless network or other similar configuration for allowing communication among two or more computing devices. Connected to the network 102 may be general purpose computing devices 104, 108. Computing devices 104, 108 include devices such as handheld devices, laptop computers or personal computers, which may be located in a home, office, retail location or other environment, and that provide an interface for user interaction with local or remote applications or systems. Computing devices 104, 108 may also be a wireless device such as a cellular phone or personal digital assistant. A social network server 106 may also be connected to the network 102 to provide any one or more of a variety of functions relating to a social network community including serving as a web server, data store, and application server and/or provide other services. Computing device 108 may be a dedicated subscriber workstation connected to the network for providing access to the social network. Computing device 104 may be a public or end user computer for accessing the social network server or the photo processor. A fulfillment center 112 may be remotely located and connected to the network 102. The fulfillment center 112 may have its own local area network 114 and a local server 116 in addition to other devices for fulfilling customer orders. A photo service provider 113 having a server 126 may also be connected to the network. The server 126 may provide local services in addition to providing communication and data exchange with the fulfillment center server 116 and data storage for digital images. The photo service provider 113 may have equipment for producing finished products in addition to an order taking system for servicing content providers. In addition to typical devices found in any office environment, the fulfillment center 112 or photo service provider 113 may include a large photo format printer 118, ink jet printers 120, 128 gift card equipment 124, 130, imprinting equipment 122 or other devices for transferring images onto a variety of mediums.

Generally, the present invention relates to enabling a subscriber using the workstation 108 to upload low-resolution images to the social network server 106, simultaneously and in a distinct transaction, provide high-resolution copies of the same images to the photo service provider server 126 and create image links of both image sets in a shared memory store. The image links may be stored in a database 110. In one embodiment of the present invention, the image link is generated by either or both of the receiving servers i.e. social network server 106 or photo service provider server 126. In another embodiment, the image link is generated by an image link database server. The image link enables a subscriber, end user or member of the public that is duly authorized to obtain high-resolution images from the photo service server 126 when they request an image copy from the low-resolution image that is presented by the social network server 106.

In an embodiment of the present invention, the request for a copy of the digital image from social network server 106 also further results in an automated order placement with the fulfillment center 112. The fulfillment center 112 processes and delivers finished products derived from the high-resolution version of the requested digital image stored on the photo service provider server 126. In a further embodiment, when images are updated or otherwise modified on the photo service server 126, the social network server 106 is forwarded the low resolution format of the updated image. In other words, image editing tools and features available for the photo service provider system may be utilized to effectively edit images stored on a social network site without the need for any further action or steps by an end user.

In an even further embodiment of the present invention, applications on one or more social networking sites 106 or elsewhere may be used to create simple prints or more complex products such as photobooks from low-resolution images. In this case, an order is sent to a server that is hosting the Image link database 110. The server pulls high-resolution files from the linked one or more photo service provider servers 126 and uses them to render the high-resolution files for fulfillment.

In order to provide the high-resolution image to the end user, one or more software programs, such as an application program interface (API) facilitate the simultaneous storage of a high-resolution image to a photo service provider server 126 when the low-resolution image is first uploaded to the social network server 106. The API also facilitates the storage of the relational information pertaining to both image sets (i.e., the image link). A similar application program interface also facilitates the required image link lookup and subsequent query of the appropriate high-resolution data store when a request is made at the social network server 106. The relational information or image link facilitates identification and access to either image format from either server environment. The present invention allows subscribers to seamlessly and transparently store and provide high-resolution images while working with a social network that only supports low-resolution images. More specifically, the present invention provides a methodology for a collaborative utilization of features from dissimilar websites and enables the linking of images between the websites.

### Representative Implementation

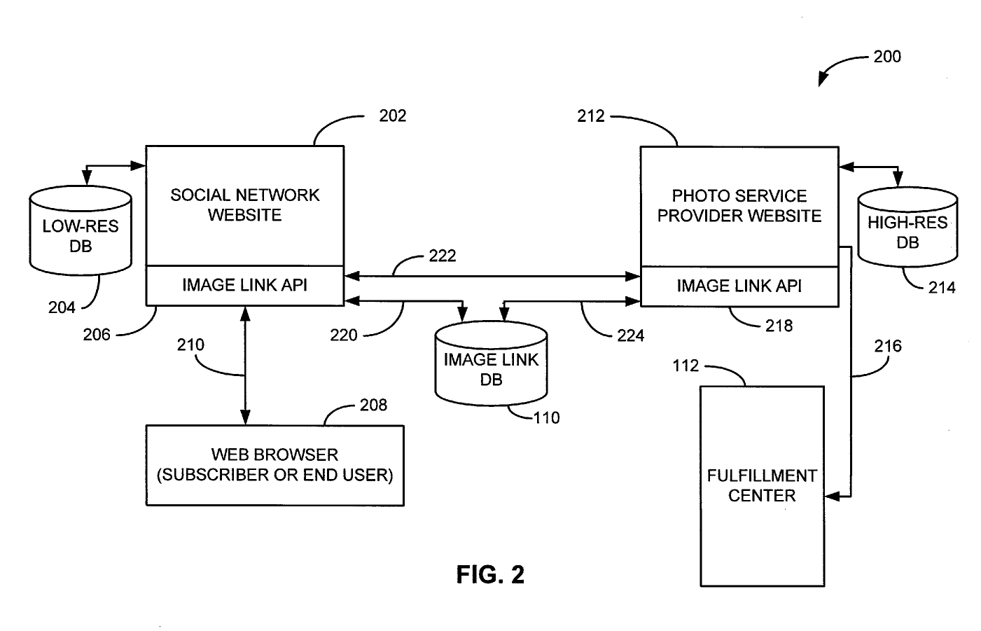

The present invention and the advantages thereof can be further appreciated by considering a representative implementation described with initial reference to FIG. 2. The discussions hereafter are in reference to aspects that are relevant to digital images. However, this should not be construed as limiting the spirit and scope of the present invention and features thereof. Referring to the block diagram illustration 200, the component programs and data stores useful in performing the method of the present invention will be described. As shown, a social network website 202, such as Facebook.com, has connected thereto, a data base 204 for the storage of low-resolution images along with other information relevant to subscribers. While the discussions herein refer to databases as a particular type of data store (e.g., low-resolution database 204), it should be understood that there may be other informational items stored therein. A first image link API 206 operates in conjunction with the social network website 202. A web browser 208, which may be executing on the end user device 104 or subscriber workstation 108, is operable to interact with the social network site 202 for a variety of functions including viewing, uploading and requesting image copies. As shown by the communication path 210, the communication between the web browser 208 and the social network website 202 is bi-directional. In other words, the communication path 210 represents such activities as the upload of digital images to the social network 202 or the request of images for download or printing. Importantly, the communication path 210 is through the image link API 206 to the social network website 202.

Also shown, is a photo service provider website 212, having a data store 214 for the storage of among other things, high-resolution digital images. The photo service provider website 212 may be any conventional photo processing site within the photography community, such as Flickr.com. Accordingly, it would be understood that users of the photo service provider website 212 are able to, among other functions, upload digital images and obtain high quality prints, image compact disks (CD), and other renderings of the images. As previously explained, a fulfillment center 112 may be utilized by the photo service provider 113 to fulfill a print order (i.e., prints, data retrieval, etc.) or provide additional related services. As such, the photo service provider website 212 may have a communication path 216 to the fulfillment center 112. A second image link API 218 operates in conjunction with the photo service provider website 212 to provide the features of the present invention.

In operation, a representative communication path 222 enables the necessary handshaking, validation and interchange that is required between the first API 206 and the second API 218. The image link database 110 is in operative communication with the first API 206 via communication path 220 and the second API 218 via communication path 224.

Having described the network environment and the component application programs of the present invention along with the interaction there between, attention is next directed to the logic flow and operational steps of the invention. The discussion of the logic flow and operations will further highlight some of the other salient features of the invention.

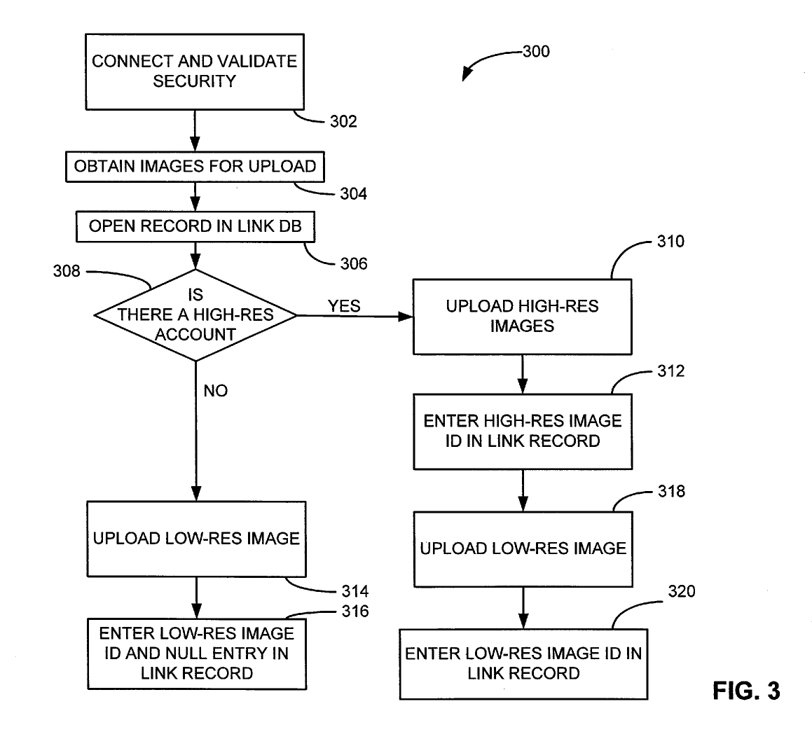

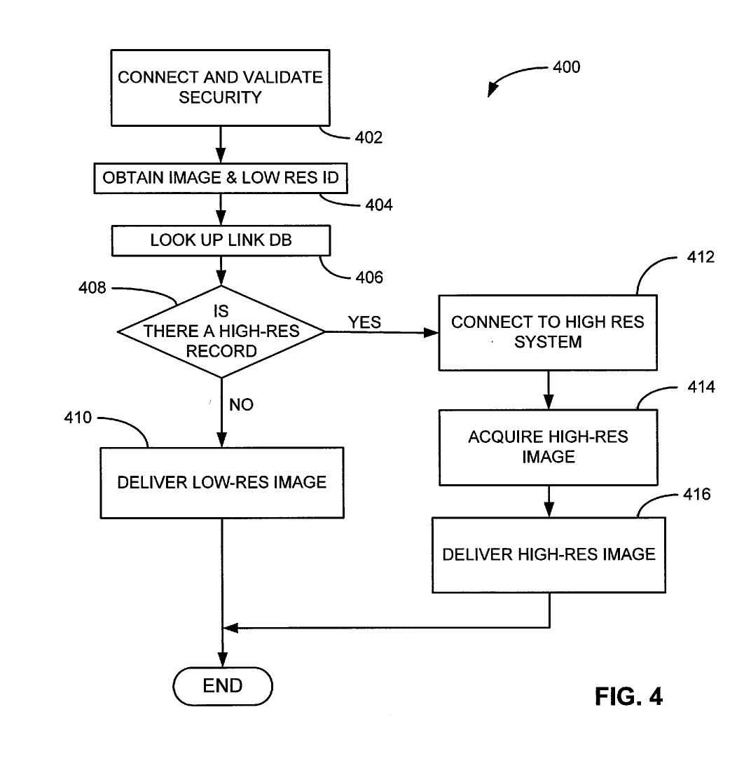

The logic flow is best described with reference to FIG. 3 and FIG. 4. The system and method of the present invention is best conceptualized by considering the steps 300 as they apply to the earlier described components—website 202, web browser 208, photo service provider website 212 and the various data stores 204, 214, 110, and the interactions there between. As would be appreciated by one skilled in the art, any one or more of the components, data store and logic may be implemented as a combination of software and/or hardware and the functions performed within any one component or logic step are not strictly limited to such component or logic step. To the contrary, functions may be dispersed or consolidated among the individual components or multiple numbers of similar components. These variations are anticipated and are within the scope of this invention.

In an embodiment of the present invention, a subscriber with an account on the social network site 202 may employ the workstation 108 and be operatively connected through the browser 208 to the social network site 202. As was previously established, the social network site 202 for a variety of reasons including technical and cost driven concerns is limited to operating with low-resolution images, and thus only accepts and stores such digital image format. However, for reasons such as image quality, it is desirable to have high-resolution copies of the low-resolution images that are stored on the social network site 202. As such, according to the present invention, when the subscriber desires to provide digital images to the social network site 202, a connection to the server 106 is first established at step 302. Security authentication is performed to ensure privacy and access rights. The subscriber may then provide images for upload via the image link API 206, at step 304. It should be understood that the image link API 206 may also provide simultaneous upload to more than one social network sites 202.

Utilizing features already present within the social network website 202 or otherwise, a unique image identification and subscriber identification are obtained by the API 206. The API 206 opens a new record in the image link database 110 via communication path 220, at step 306. The new record comprises at least a low resolution identifier field and a high resolution identifier field. The record may further comprise a subscriber identification field. In one embodiment of the present invention, the unique image identification is entered into the low resolution identifier field of the new record at this stage. Next, a determination is made regarding whether the subscriber is an account holder with the photo service provider website 212, at step 308. This determination occurs over communication path 222. If it is determined that the subscriber is not an account holder with the photo service provider website 212, program execution proceeds to step 314. Otherwise execution proceeds to step 310.

At step 314, a low-resolution image is uploaded to the low-resolution database 204. At step 316, the new record is provided with an image identifier for the low resolution image the appropriate field and a NULL entry in the high-resolution identifier field.

Alternatively, at step 310, since the subscriber is an account holder, the second image link API 218 facilitates uploading a high-resolution image to the high-resolution database 214 and obtains a high-resolution image identifier. At step 312, the second image link API 218 provides the high-resolution image identifier as a field entry in the new record that was previously accessed in the image link database 110. A low-resolution image is uploaded to the low-resolution database 204 at step 318. An image identifier for the low resolution image is then provided as another field entry in the previously identified record, at step 320.

In an alternate embodiment of the invention, the inquiry at step 308 is completely circumvented and the need for a prior account with the photo service provider website 212 becomes irrelevant. In this scenario, the low-resolution and high-resolution images are saved in one distinct transaction. High-resolution images are saved to the high-resolution database 214, and a high-resolution image identifier is generated for relational storage with the previously obtained low-resolution image identification.

The uploading process described above may involve multiple social network websites 202 and multiple photo service provider websites 212. In such a scenario an additional field may be provided within the image link database 110 to identify the relevant websites 202, 212 for each image link record. Furthermore, the subscriber may upload images to the individual websites 202,212 in multiple transfer transactions or perform a single upload to a server that manages the Image link database 110. The uploaded images may then be forwarded/propagated to relevant destination social network servers 106 and/or photo service provider servers 126 as selected by the subscriber.

Turning next to FIG. 4, and the logic flow 400 illustrated therein, a subscriber utilizing the workstation 108 or an end user utilizing the workstation device 104, each operating through the browser 208 seek to acquire an image from the social network site 202. The following discussion will be with reference to an end user rather than a subscriber as it is understood that access to images on the social network site can be granted to non-subscribers. The process for downloading or otherwise receiving images is independent of the status of the recipient. As such, when the end user desires to obtain digital images from the social network site 202, a connection is first established at step 402. Security authentication is performed to ensure privacy and provide proper access. The end user having selected one or more images for download communicates with the social network site 202 via the image link API 206, at step 404.

Generally, utilizing features already present within the social network website 202, such as the fact that each image is assigned a unique image identifier, the first image link API 206 obtains the image identification for the high-resolution image from the high-resolution database 214. This information may then be employed to discover the high resolution image located on the photo service provider server 126.

In operation, the API 206 searches for a record in the image link database 110 via communication path 220, utilizing the image identification, at step 406. In one embodiment, the subscriber identification is also utilized as a search criteria, at step 406. Next, a determination is made regarding whether a record exists, or if the identified record has an entry in the field for the high-resolution image identifier, at step 408. This determination occurs over communication path 220. If there is no entry (i.e., the high-resolution identifier field is NULL), meaning that no high-resolution image exists, then processing proceeds to step 410. At step 410, the low-resolution image is delivered to the end user. Alternatively, if there is an entry for the high-resolution image identifier, then processing proceeds to step 412.

At step 412, a connection is established via communication path 222 to the second image link API 218. The high-resolution database 214 may then be queried for the image file or image data associated with the high-resolution identifier, at step 414. When the image is identified or otherwise located, the high-resolution image is delivered to the end user at step 416.

The system and method of the present invention may provide a convention/set of rules for the structure, content and use of tags in an image link manifest Extensible Mark-up Language (XML) file rather than a database, thereby providing an interrelationship among the several data items described earlier, such as, the low-resolution image identifier, subscriber identification and high-resolution image identifier.

Having described the system and method of the present invention and an embodiment thereof, an exemplary computer environment for implementing the described design and execution is presented next.

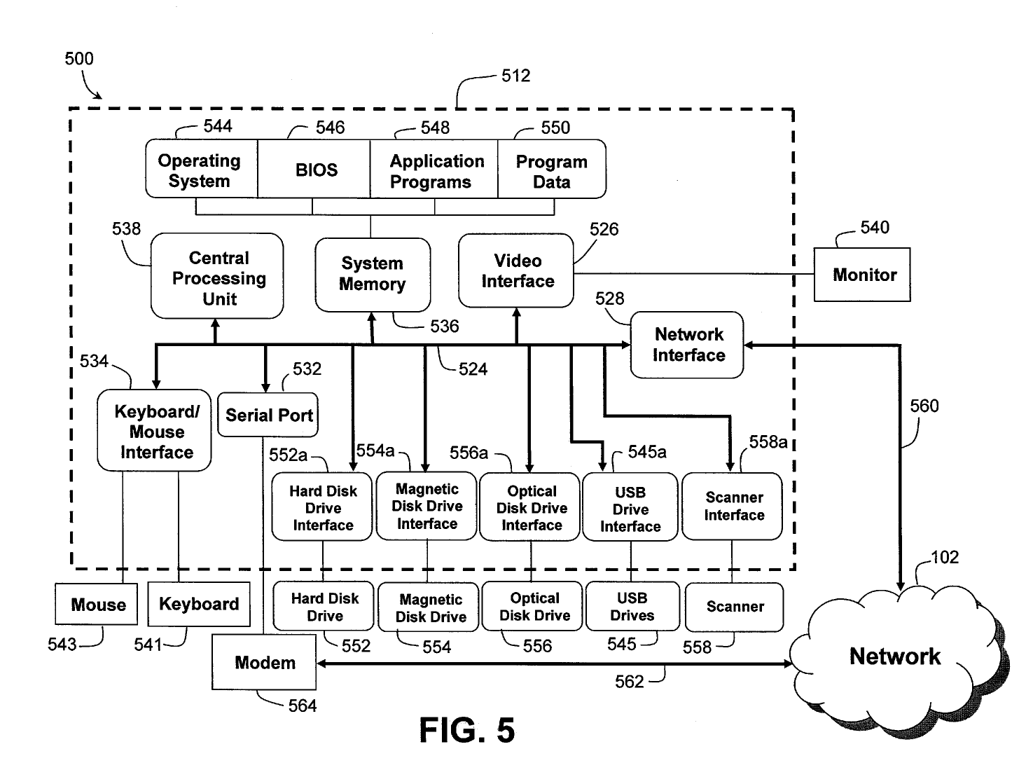

FIG. 5 shows an exemplary computing environment 500 that can be used to implement any of the processing thus far described. Computing environment 500 may include one or more computers 512 (such as computing devices 104, 108) comprising a system bus 524 that couples a video interface 526, network interface 528, a keyboard/mouse interface 534, and a system memory 536 to a Central Processing Unit (CPU) 538. A monitor or display 540 is connected to bus 524 by video interface 526 and provides the user with a graphical user interface to view, edit, and prepare a print order using digitally represented still images. The graphical user interface allows the user to enter commands and information into computer 512 using a keyboard 541 and a user interface selection device 543, such as a mouse or other pointing device. Keyboard 541 and user interface selection device are connected to bus 524 through keyboard/mouse interface 534. The display 540 and user interface selection device 543 are used in combination to form the graphical user interface which allows the user to implement at least a portion of the present invention. Other peripheral devices may be connected to the remote computer through universal serial bus (USB) drives 545 to transfer information to and from computer 512. For example, cameras and camcorders may be connected to computer 512 through serial port 532 or USB drives 545 so that data representative of a digitally represented still image or video may be downloaded to system memory 536 or another memory storage device associated with computer 512 such that the images may be subsequently printed by one or more fulfillment centers 112 in accordance with the present invention.

The system memory 536 is also connected to bus 524 and may include read only memory (ROM), random access memory (RAM), an operating system 544, a basic input/output system (BIOS) 546, application programs 548 and program data 550. The computer 512 may further include a hard disk drive 552 for reading from and writing to a hard disk, a magnetic disk drive 554 for reading from and writing to a removable magnetic disk (e.g., floppy disk), and an optical disk drive 556 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media xD card), and a scanner 558 for scanning items such as still image photographs to be downloaded to computer 512. A hard disk drive interface 552a, magnetic disk drive interface 554a, an optical drive interface 556a, a USB drive interface 545a, and a scanner interface 558a operate to connect bus 524 to hard disk drive 552, magnetic disk drive 554, optical disk drive 556, USB drive 545 and scanner 558, respectively. Each of these drive components and their associated computer-readable media may provide remote computer 512 with non-volatile storage of computer-readable instruction, program modules, data structures, application programs, an operating system, and other data for computer 512. In addition, it will be understood that computer 512 may also utilize other types of computer-readable media in addition to those types set forth herein, such as digital video disks, random access memory, read only memory, other types of flash memory cards, magnetic cassettes, and the like.

Computer 512 may operate in a networked environment using logical connections with fulfillment centers 112. Network interface 528 provides a communication path 560 between bus 524 and network 102, which allows, for example, a print order to be communicated through network 102 from photo service provider 113 to fulfillment centers 112 after the print order has been established, and optionally saved in a memory. This type of logical network connection is commonly used in conjunction with a local area network (LAN). The print order may also be communicated from bus 524 through a communication path 562 to network 102 using serial port 532 and a modem 564. Using a modem connection between the computer 512 and photo service provider 113 and/or fulfillment center 112 is commonly used in conjunction with a wide area network (WAN). It will be appreciated that the network connections shown herein are merely exemplary, and it is within the scope of the present invention to use other types of network connections between remote computer 512, photo service provider(s) 113, and fulfillment centers 112 including both wired and wireless connections.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirements.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A method programmed for execution in a computing environment for providing a digital image to a first website that supports a first resolution format of the digital image and a second website that supports a second resolution format of the digital image, the method comprising:
receiving from the digital image to be stored to the first website;
storing the digital image in the first resolution format to the first website and associating therewith a unique first type identifier;
connecting to the second website;
storing the second resolution format of the digital image to the second website and associating therewith a unique second type identifier; and
storing in a related manner said first and second unique type identifiers, wherein the first resolution format of the digital image is linked to the second resolution format of the digital image.

2. A method in accordance with claim 1, wherein the second resolution format of the digital image is provided by accessing the first website, further comprising:
receiving a request for a copy of the digital image on the first website;
determining the unique first type identifier of the digital image;
utilizing the related storage to obtain the second type identifier of the requested digital image; and
connecting to the second website and employing the second type identifier to obtain the second resolution format of the digital image.

3. A method in accordance with claim 1, further comprising:
manipulating the second resolution format of the digital image on said second website to make changes;
determining the unique second type identifier of the digital image;
utilizing the related storage to obtain the first type identifier of the digital image; and
connecting to the first website and employing the first type identifier to provide a first resolution format of the changed second resolution format of the digital image.

4. A method in accordance with claim 1, wherein the first resolution format is a low resolution digital image format and said second resolution format is a high resolution digital image format.

5. A method in accordance with claim 1, wherein the first website is a social network site and the second website is a photo service provider website.

6. A method in accordance with claim 1, wherein the unique first type identifier is provided by the first website.

7. A method in accordance with claim 1, wherein the unique first type identifier is provided by the first website and the unique second type identifier is provided by the second website.

8. A method in accordance with claim 1, wherein the storing of the first and second type identifiers in a related manner is provided in an Extensible Markup Language (XML) manifest.

9. A method in accordance with claim 8, wherein the XML manifest comprises rules for structure and content for the linking of the first resolution format of the digital image to the second resolution format of the digital image.

10. A method for execution in a computing environment for providing from a first website that supports a first resolution format of a digital image, a second resolution format of the digital image, the method comprising:
receiving from one of a plurality of users the digital image to be stored to the first website;
providing a unique first type identifier and storing the first resolution format of the digital image to the first website;
connecting to a second website, the second website providing support for the second resolution format;
providing a unique second type identifier and storing the second resolution format of the digital image to the second website;
storing in a related manner the first and second unique type identifiers, wherein the first resolution format of the digital image is linked to the second resolution format of the digital image;
receiving a request for a copy of the digital image on the first website;
determining the unique first type identifier of the digital image;
utilizing the related storage to obtain the second type identifier of the requested digital image; and
connecting to the second website and employing the second type identifier to obtain the second resolution format of the digital image.

11. A method in accordance with claim 10, wherein the first resolution format is a low resolution digital image format and the second resolution format is a high resolution digital image format.

12. A method in accordance with claim 10, wherein the first website is a social network site and the second website is a photo service provider website.

13. A method for execution in a computing environment for propagating updates of a first resolution of a digital image located on a first website to a second website having a second resolution of the digital image located thereon, the method comprising:
providing a unique first type identifier for the first resolution digital image;
providing a unique second type identifier for the second resolution digital image;
storing in a related manner the first and second unique type identifiers to thereby link the first resolution format of the digital image to the second resolution format of the digital image, wherein either resolution digital image may be identified given the other resolution digital image;
recognizing an update to the first resolution digital image, wherein the first resolution is a higher resolution format than the second resolution;
providing a second resolution format of said updated first resolution digital image; and
utilizing the related storage of the first and second unique type identifies to identify and replace the related second resolution digital image with the second resolution format of the updated first resolution digital image.

14. A method in accordance with claim 13, wherein the first resolution is a low resolution digital image format and the second resolution is a high resolution digital image format.

15. A method in accordance with claim 13, wherein the first website is a social network site and the second website is a photo service provider website.

16. A method in accordance with claim 13, wherein the update to the first resolution digital image is a cropping of the digital image.

17. A method in accordance with claim 13, wherein the update to the first resolution digital image comprises enhancements to the digital image.
